(19) United States
(12) Patent Application Publication
(10) Pub. No.: US 2025/0045258 A1
(43) Pub. Date: Feb. 6, 2025

(54) AUGMENTED SIMULANT CALIBRATION OF GEOSPATIAL DATA FOR PROPERTY QUANTIFICATION

(71) Applicant: Sentinel Fertigation, Inc., Lincoln, NE (US)

(72) Inventors: Nishan Khatri, Omaha, NE (US); Jackson Stansell, Lincoln, NE (US)

(21) Appl. No.: 18/790,919

(22) Filed: Jul. 31, 2024

Related U.S. Application Data
(60) Provisional application No. 63/529,952, filed on Jul. 31, 2023.

(51) Int. Cl. G06F 16/215; G06F 16/25; G06F 16/29

(52) U.S. Cl. CPC G06F 16/215; G06F 16/258; G06F 16/29

(57) ABSTRACT

A system for simulant calibration may include a controller. The controller may collect geolocated data for an entire area; extract one or more VOIs for each AP; extract the VOIs within each AROI to form an AROI VOI distribution; apply one or more simulant calibration models to the AROI VOI distribution to determine simulant calibration VOI values; compute error between the mean VOI value for each AP and the simulation calibration VOI values for the AROI associated with each AP; correct the simulant calibration VOI values for ROI without APs; compute one or more calibration ratios for pairs in proximal plot groups; deliver the one or more calibration ratios to a recommendation algorithm; add the AP mean VOI values and the AROI VOI distribution for the intersecting ROI to a simulant calibration model; and train and validate the simulant calibration model.

### CROSS REFERENCE TO RELATED APPLICATIONS

The present application claims the benefit under 35 U.S.C. § 119 (e) of U.S. Provisional Application No. 63/529,952, filed Jul. 31, 2023, which is incorporated herein by reference in the entirety.

### TECHNICAL FIELD

This disclosure relates to monitoring plant nutrient sufficiency, and, more particularly, to calibration techniques related to monitoring plant nutrient sufficiency.

### BACKGROUND

Presently, there are four principal techniques for calibration of monitoring plant nutrient sufficiency.

One method of calibration uses a high nitrogen (high N) reference. Here, at least one region in a field may be configured as a reference plot (e.g., a reference or N-rich strip). The reference plot is required to be fertilized with an excess amount of nitrogen, thus ensuring that a crop is not nitrogen limited. Optical reflectance measurements may be collected throughout the field as a whole. These optical reflectance measurements may be transformed into vegetation index (VI) values. Calibration may include comparing VI values collected in different regions of the field to the mean (e.g., average) VI value of the reference plot. The value from such a comparison may constitute a sufficiency index (SI). This method may rely on a single-point calibration. Calibration using a high nitrogen reference is disclosed in T. M. Blackmer & J. S. Schepers (1994) Techniques for monitoring crop nitrogen status in corn, Communications in Soil Science and Plant Analysis, 25:9-10, 1791-1800, DOI: 10.1080/00103629409369153, which is incorporated herein by reference in its entirety.

Another method of calibration uses a low nitrogen (low N) reference. Here, at least one region in a field may be configured as a control plot (e.g., an N-poor strip or a canary). The control plot may be under-fertilized such that the crops in the control plot are nitrogen limited. Optical reflectance measurements may be collected throughout the field as a whole. These optical reflectance measurements may be transformed into VI values. Calibration may include comparing the VI values collected from other areas of the field to a mean VI value from the control plot. The value from such a comparison may constitute a response index (RI). Calibration using a low nitrogen reference is disclosed in Johnson, G. V., & Raun, W. R. (2003). Nitrogen response index as a guide to fertilizer management. Journal of plant Nutrition, 26 (2), 249-262, which is incorporated herein by reference in its entirety.

Another method of calibration uses paired plot calibration. Here, over-fertilized and under-fertilized regions of a field are established. The over-fertilized and under-fertilized regions are paired, and located proximal to each other. The over-fertilized region may be referred to as the reference plot while the under-fertilized region may be referred to as the canary plot. Calibration may include collecting optical reflectance measurements from both the reference plot and the canary plot. These optical reflectance measurements may then be transformed into VI values. The VI values of the canary plot may then be divided by the mean VI value of the reference plot to produce canary plot sufficiency index (SI) values. The mean canary plot SI value may be referred to as either the sufficiency index (SI) or the sufficiency response index (SRI). The method of paired plot calibration may be considered a two-point calibration. Calibration using paired plot calibration is described in Stansell, J. (2021). “Development and Automation of a Sensor-Based Fertigation Management Framework for Improved Nitrogen Use Efficiency and Profitability in Irrigated Row Crop Production Systems” and U.S. Patent Publication No. 20230018041A1, entitled “Optical analysis paired plot automated fertigation systems, methods and data structures” and published on Jan. 19, 2023, which are incorporated herein by reference in their entirety.

Another method of calibration uses a virtual reference. Here, optical reflectance measurements may be collected throughout a geospatial region. These collected optical reflectance measurements may be transformed into VI values. The VI values may be statistically interpreted based on a histogram and/or distribution parameters to determine a minimum, a mean, and a reference value for the geospatial region. The reference value may be chosen from the VI values at an arbitrary percentile (e.g., the 95th percentile) of the VI value distribution. The minimum value may be chosen from the VI values at an arbitrary percentile (e.g., the 20th percentile) of the VI value distribution. The mean value may simply be the average of all VI values. Calibration may include dividing all of the collected VI values by the reference VI value in order to determine SI values associated with each VI value. An additional parameter, referred to as either the difference SI value or the delta SI value may also be computed by comparing the minimum SI value and the maximum SI value. Calibration using a virtual reference is described in Holland, K. H., & Schepers, J. S. (2013). Use of a virtual-reference concept to interpret active crop canopy sensor data. Precision Agriculture, 14 (1), 71-85 and U.S. Pat. No. 8,816,262, entitled “Auto-calibration method for real-time agricultural sensors” and issued on Aug. 26, 2014.

However, accurate measurements and/or accurate plots using this method may be difficult to achieve. Therefore, there is a desire to cure the deficiencies related to inaccurate plots and/or measurements that may be part of previous methods.

### SUMMARY

A system for augmented simulant calibration is disclosed. In embodiments, the system includes a controller, wherein the controller includes one or more processors configured to execute program instructions stored on memory, the program instructions configured to cause the one or more processors to: collect geolocated data for an entire area, wherein the entire area is defined by an exterior boundary; generate analytic plots and analytic regions of interest; extract one or more values of interest for the entire area defined by the exterior boundary for each analytic plot; generate an analytic region of interest value of interest distribution; determine simulant calibration value of interest values associated with an analytic region of interest centroid; correct the simulant calibration value of interest values for the region of interest that do not intersect the analytic plots based on an estimated error; compute one or more calibration ratios for pairs in proximal plot groups to use for simulant application recommendations; and update the executed model and a simulant calibration model training and validation database.

An additional system for augmented simulant calibration is disclosed. In embodiments, the system includes a controller, wherein the controller includes one or more processors configured to execute program instructions stored on memory, the program instructions configured to cause the one or more processors to: collect geolocated data for an entire area, wherein the entire area is defined by an exterior boundary; perform an intersection operation on any location where calibration plots intersect a region of interest to produce analytic plots; perform a difference operation on any location where the analytic plots intersect the region of interest to produce an analytic region of interest; extract one or more values of interest for the entire area defined by the exterior boundary for each analytic plot; compute a mean value of interest for each analytic plot; extract the values of interest within each analytic region of interest geospatial boundary to form an analytic region of interest value of interest distribution; apply one or more simulant calibration models to the analytic region of interest value of interest distribution to determine simulant calibration value of interest values; associate the simulant calibration value of interest values with an analytic region of interest centroid; compute error between the mean value of interest value for each analytic plot and the simulation calibration value of interest values for the analytic region of interest associated with each analytic plot; correct the simulant calibration value of interest values for regions of interest that do not intersect the analytic plots; compute one or more calibration ratios for pairs in proximal plot groups; deliver the one or more calibration ratios to a recommendation algorithm for further transformation and processing; add the analytic plot mean value of interest values and the analytic region of interest value of interest distribution for the intersecting region of interest to a simulant calibration model training and validation database; and train and validate the simulant calibration model with an updated simulant calibration model training and validation database in order to update the executed model.

A method of simulant calibration is disclosed. In embodiments, the method includes collecting geolocated data for an entire area, wherein the entire area is defined by an exterior boundary. In embodiments, the method includes performing an intersection operation on any location where calibration plots intersect a region of interest to produce analytic plots. In embodiments, the method includes performing a difference operation on any location where the analytic plots intersect the region of interest to produce an analytic region of interest. In embodiments, the method includes extracting one or more values of interest for the entire area defined by the exterior boundary for each analytic plot. In embodiments, the method includes computing a mean value of interest for each analytic plot. In embodiments, the method includes extracting the values of interest within each analytic region of interest geospatial boundary to form an analytic region of interest value of interest distribution. In embodiments, the method includes applying one or more simulant calibration models to the analytic region of interest value of interest distribution to determine simulant calibration value of interest values. In embodiments, the method includes associating the simulant calibration value of interest values with an analytic region of interest centroid. In embodiments, the method includes computing error between the mean value of interest value for each analytic plot and the simulation calibration value of interest values for the analytic region of interest associated with each analytic plot. In embodiments, the method includes correcting the simulant calibration value of interest values for region of interest that do not intersect the analytic plots. In embodiments, the method includes computing one or more calibration ratios for pairs in proximal plot groups. In embodiments, the method includes delivering the one or more calibration ratios to a recommendation algorithm for further transformation and processing. In embodiments, the method includes adding the analytic plot mean value of interest values and the analytic region of interest value of interest distribution for the intersecting region of interest to a simulant calibration model training and validation database. In embodiments, the method includes training and validating the simulant calibration model with an updated simulant calibration model training and validation database in order to update the executed model.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1A illustrates reference distances from a canary plot to a centroid of a region of interest (ROI), in accordance with one or more embodiments of the present disclosure.

FIG. 1B illustrates reference distances from a reference plot to a centroid of a ROI, in accordance with one or more embodiments of the present disclosure.

FIG. 1C illustrates simulant calibration based on calibration zones, in accordance with one or more embodiments of the present disclosure.

FIG. 2A illustrates simulant calibration based on calibration grid cells, in accordance with one or more embodiments of the present disclosure.

FIG. 2B illustrates simulant calibration based on calibration grid cells, in accordance with one or more embodiments of the present disclosure.

FIG. 3 illustrates frequency distribution graphs used in simulant calibration, in accordance with one or more embodiments of the present disclosure.

FIG. 4 illustrates a block diagram of a system for simulant calibration, in accordance with one or more embodiments of the present disclosure.

FIG. 5 illustrates a flow diagram depicting a method of simulant calibration, in accordance with one or more embodiments of the present disclosure.

FIG. 6A illustrates a graph depicting actual versus predicted values for a canary plot, in accordance with one or more embodiments of the present disclosure.

FIG. 6B illustrates a graph depicting actual versus predicted values for a corrected canary plot, in accordance with one or more embodiments of the present disclosure.

FIG. 6C illustrates a graph depicting actual versus predicted values for a corrected canary aggregate plot, in accordance with one or more embodiments of the present disclosure.

FIG. 6D illustrates a graph depicting a comparison of correlative measures for the graphs in FIGS. 6A-6C, in accordance with one or more embodiments of the present disclosure.

FIG. 7A illustrates a graph depicting actual versus predicted values for a reference plot, in accordance with one or more embodiments of the present disclosure.

FIG. 7B illustrates a graph depicting actual versus predicted values for a corrected reference plot, in accordance with one or more embodiments of the present disclosure.

FIG. 7C illustrates a graph depicting actual versus predicted values for a corrected reference aggregate plot, in accordance with one or more embodiments of the present disclosure.

FIG. 7D illustrates a graph depicting a comparison of correlative measures for the graphs in FIGS. 7A-7C, in accordance with one or more embodiments of the present disclosure.

FIG. 8A illustrates a graph depicting actual versus predicted values for a sufficiency index (SI) plot, in accordance with one or more embodiments of the present disclosure.

FIG. 8B illustrates a graph depicting actual versus predicted values for a corrected SI plot, in accordance with one or more embodiments of the present disclosure.

FIG. 8C illustrates a graph depicting actual versus predicted values for a corrected SI aggregate plot, in accordance with one or more embodiments of the present disclosure.

FIG. 8D illustrates a graph depicting a comparison of correlative measures for the graphs in FIGS. 8A-8C, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to simulant calibration. In embodiments, multispectral optical reference data may be used to quantify plant nutrient sufficiency. In order for the multispectral optical reference data to be accurate, it should be calibrated for plant response when the plants are under different nutrient availability conditions (e.g., low nutrient availability, normal nutrient availability, or high nutrient availability). Typically, calibration techniques rely on establishing nutrient rich regions and nutrient poor regions in the soil by using more or less nitrogen fertilizer. Such nutrient rich regions and nutrient poor regions may be referred to as calibration plots.

Accurate creation of the calibration plots may be operationally challenging because creation of the plots requires accurate information of machine function (e.g., the function of the machine fertilizing the calibration plots) and execution by a skilled machine operator. Therefore, calibration plots are often inaccurately established and may require significant manual intervention to correct the calibration plots. Further, establishing calibration plots may limit the applicability of accurate nutrient recommendation technologies to locations (e.g., fields) where calibrations plots have been established (e.g., the calibration plots were established because of sufficient operation capabilities and/or the technology was used early enough to establish the calibration plots).

Embodiments of the present disclosure provide for site-specific simulation of geolocated optical reflectance data calibration and correction of the simulated calibration using data from proximal ground-truth calibration plots. This may minimize information requirements and challenges associated with establishing calibration plots, mitigate the impacts of inaccurately established calibration plots, empower accurate calibration despite operation and/or machinery limitations to establishing accurate calibration plots, and enable accurate nutrient sufficiency quantification without calibration plot establishment.

A simulant calibration model may be trained using collected geospatial (e.g., geolocated) data and known calibration plot locations that have been established to manipulate response in the natural environment. The model may be trained such that it determines weights to convert an input geospatial data value distribution with no other contextual information to an output calibration value. An independent model may be constructed for each calibration value level (e.g., type) desired (e.g., high, intermediate, or low). Each model may then be executed for an individual region of interest (ROI). The model architecture may be configured to be continuously trained and updated (e.g., via artificial intelligence and/or machine learning) as new data is received and may be broadly applicable to a variety of environmental and management variables.

The systems and methods for constructing a simulant calibration model may have multiple benefits over prior calibrations methods. The system and method disclosed herein may require fewer (or no) calibration plots to be established with excess or deficient amounts of nutrients, which may preserve yield potential, mitigate environmental risk associated with excess nutrient reference plots, and eliminate the necessity for a machine information exchange. The hybrid/augmented implementation may require fewer plots to be used, allowing an increase in plot size, which may make it more likely for a machine to intersect the plots along a path of movement, make it more likely for a rate controller to find a rate while in the plots, and require less caution by an operator to preserve their health and wellness. Fields (e.g., exterior boundaries) with many ROIs, where there is not a plot in each ROI, may be more accurately calibrated using the augmented/hybrid techniques disclosed herein because the predicted values may be closer to the actual values. Exterior boundaries may be enrolled and recommendations (e.g., recommendations of fertilizer amount) may be made accurately at any point during the growing season. There may also be little (or no) human interaction or intervention required to initialize calibration. Augmented/hybrid simulant calibration may also be more resistant to noise than other calibration techniques because of the combination of ground-truth and larger ROIs that mitigate possible errors in data geolocation.

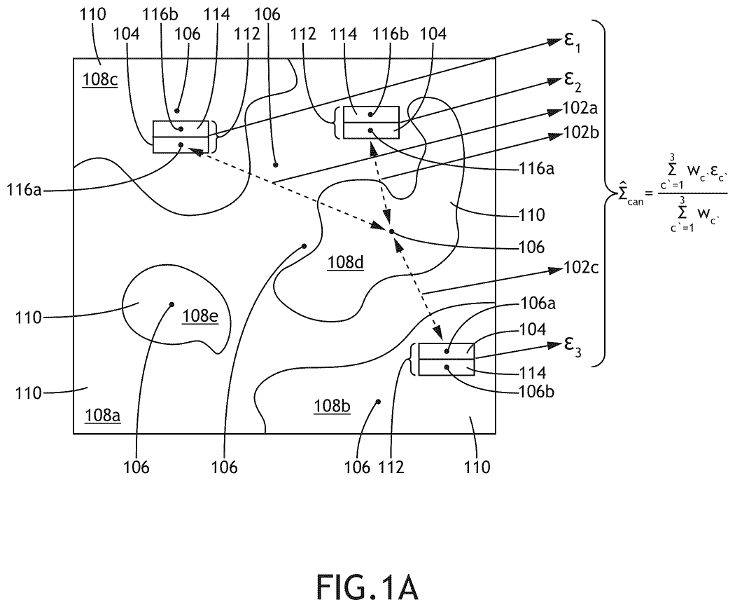

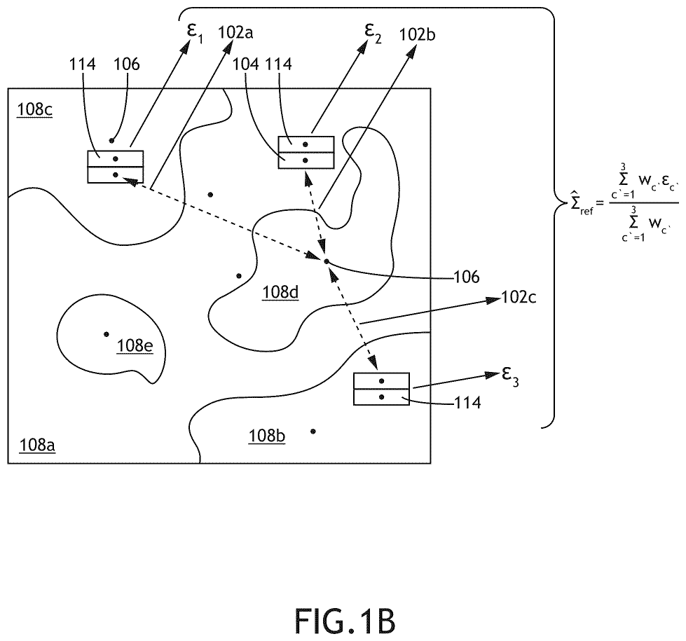

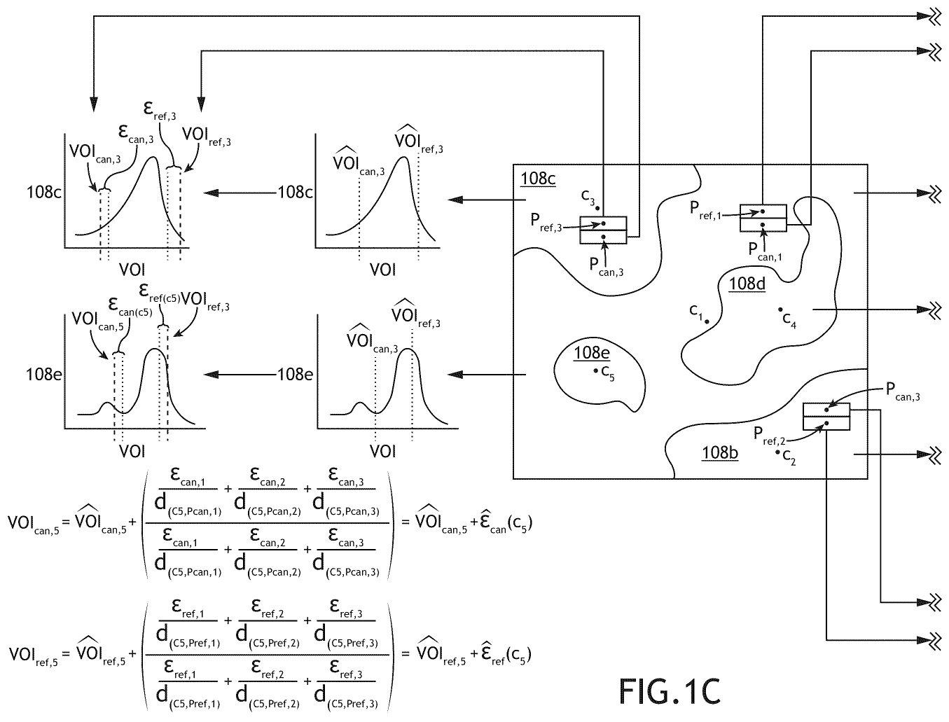

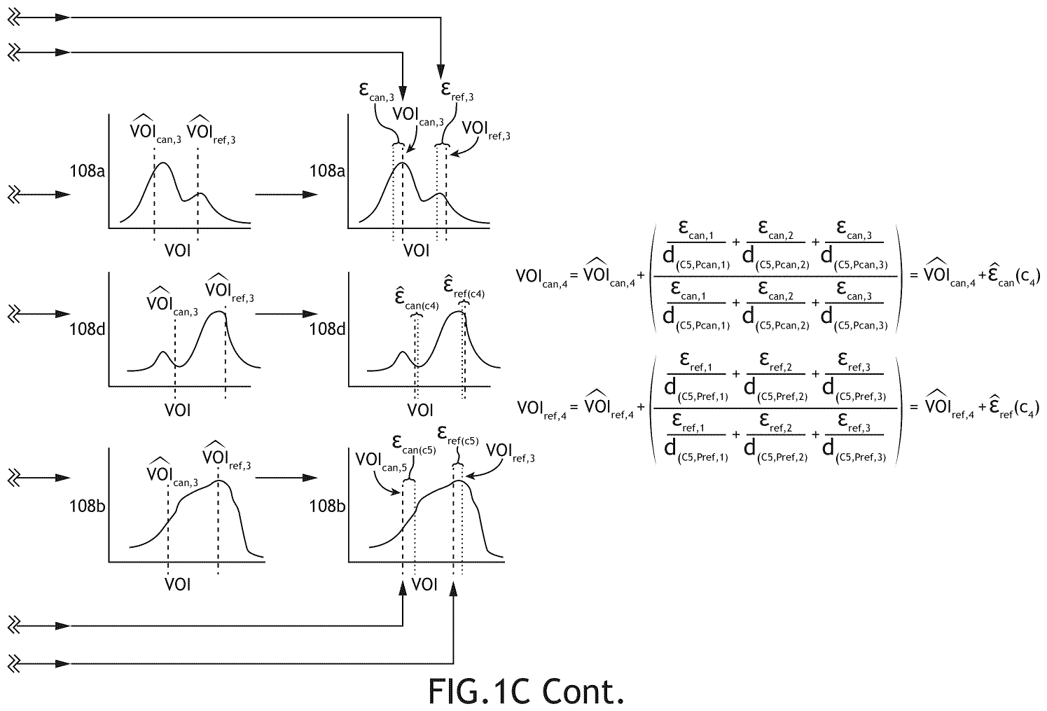

Referring now to FIGS. 1A-5, systems and methods for creating a simulant calibration model are described in greater detail.

The systems and methods disclosed herein may provide for an augmented/hybrid calibration approach for fertigation systems that integrated simulations and ground-truth values. This may allow for error correction of simulated calibration values based on proximal calibration plots. The calibration provided for by the systems and methods disclosed herein may include adaptive execution of plot-based calibration, augmented calibration and/or simulated calibration. Further, the error correction may be based on proximity (e.g., how close (e.g., in physical space) the known values are to the simulated calibration values). It is further contemplated that the augmented/hybrid calibration approach described in the present disclosure may also be applied to fertigation systems without the use of proximal calibration plots, using an adapted calculation and calibration method.

Each region of interest may also have its own specific AI model to identify canary values and reference values. Further, the simulant model may continuously learn and improve its estimation of VOI calibration values from VOI distributions based on additional data and ground-truth values from calibration plots.

FIG. 1A illustrates reference distances 102 from a canary plot 104 to a centroid 106 of a region of interest (ROI) 108, in accordance with one or more embodiments of the present disclosure.

For example, FIG. 1A illustrates five regions of interest (ROIs) 108 (e.g., ROIs 108a-108e). Each ROI 108 may be a geospatial area for which analysis is desired. Each ROI 108 may be defined by an exterior boundary 110. The exterior boundary 110 of each ROI 108 may be of any shape (e.g., following contours of a field, determined by a user, or following property lines).

Further, some ROIs 108 may include an analytical plot (AP) 112. An AP 112 may be a calibration plot that intersects with an ROI 108. Each AP 112 may include a reference plot 114 (e.g., a high nitrogen (high N) region) and a canary plot 104 (e.g., a low nitrogen (low N) region). For example, in FIG. 1A, ROI 108a, ROI 108b, and ROI 108c each include an AP 112. In this way, an analytic region of interest (AROI) may be any portion of a ROI 108 that does not overlap with an AP 112.

Each ROI 108 may include an ROI centroid (c) 106. The centroid 106 may be a point location expressed in x and y coordinates (e.g., (x, y)).

Each AP 112 (e.g., a reference plot 114 and a canary plot 104 within each AP 112) may include a plot centroid (p) 116. The plot centroid 116 may be a point location expressed in x and y coordinates (e.g., (x, y)). For example, there may be a plot centroid of canary plots 116a and a plot centroid of reference plots 116b.

In FIG. 1A, three distances 102a-102c are shown between plot centroids (p) of canary plots 116a to the ROI centroid (c) 106 in ROI 108d. For example, distance 102a is the distance between the plot centroid of the canary plot 116a in ROI 108c and the ROI centroid 106 in ROI 108d, distance 102b is the distance between the plot centroid of the canary plot 116a in ROI 108a and the ROI centroid 106 in ROI 108d, and distance 102c is the distance between the plot centroid of the canary plot 116 in ROI 108b and the ROI centroid 106 in ROI 108d. Each distance 102 may be a Euclidean distance between the plot centroid 106 and the ROI centroid 116. Equation 1, below is the equation to calculate distance between the plot centroid and ROI centroid:

$$d ( c , {p}_{i} ) = \sqrt{{\sum }_{j = 1}^{m} {( {c}_{j} - {p}_{{i}_{j}} )}^{2}} . \qquad ( Equation 1 )$$

Further, each AP 112 may include a computed error (ε) between the simulant calibration value of interest (VOI) and the actual calibration VOI for a specific AP 112 of a particular type. As used herein, “type” may refer to the type of calibration VOI value, such as high (e.g., associated with a reference plot 114), intermediate, or low (e.g., associated with a canary plot 104). The computed error may be calculated as shown in Equation 2:

$${ε}_{i} = {\overline{VOI}}_{I} - ( {p}_{i} ) . \qquad ( Equation 2 )$$

In Equation 2, V̅O̅I̅ denotes the mean VOI value, while [symbol] denotes the simulant calibration VOI value of a particular type, typically as a function of a specified location. The calculation for V̅O̅I̅ is shown in Equation 3, where t represents the number of data points in the i-th AP 112:

$${\overline{VOI}}_{i} = \frac{{\sum }_{k = 1}^{t} {VOI}_{k}}{t} . \qquad ( Equation 3 )$$

Further, [symbol] may be calculated with Equation 4, where VOI_{AROI} represents the VOI value distribution for a particular analytical region of interest, z represents a location, and f_{type} represents the simulant calibration function for a particular type:

$$( z ) = {f}_{type} ( {VOI}_{AROI ⊳ z} ) . \qquad ( Equation 4 )$$

However, in some ROIs 108 (e.g., ROIs 108 without APs 112), the error will have to be estimated. Estimated error between the simulant calibration VOI value of a particular type and the actual calibration VOI value of the particular type for an ROI that has no AP to produce an actual calibration VOI value may be denoted as \hat{ε}_{type}. This estimated error may be calculated using Equation 5, where w represents an inverse distance 102 weight associated with a particular AP 112 and the centroid of a ROI 106, which may be calculated as shown in Equation 6:

$$\hat{ε} ( c ) = \frac{{\sum }_{i = 1}^{n} {w}_{i} {ε}_{i}}{{\sum }_{i = 1}^{n} {w}_{i}} , \qquad ( Equation 5 )$$

$${w}_{i} = \frac{1}{d ( c , {p}_{i} )} . \qquad ( Equation 6 )$$

Ultimately, the VOI at an ROI centroid 106 may be calculated with Equation 7:

$$VOI ( c ) = ( c ) + \hat{ε} ( c ) . \qquad ( Equation 7 )$$

FIG. 1B illustrates distances 102 from a reference plot 114 to a centroid 106 of a ROI 108, in accordance with one or more embodiments of the present disclosure. FIG. 1B includes a similar situation to FIG. 1A, however, instead of comparing a set of canary plots 104 to the ROI centroid 106 of ROI 108d, a set of reference plots 114 are being compared to the ROI centroid 106 of ROI 108d. Thus, Equations 1-7 would be used to calculate the VOI at the ROI centroid 108d as described with reference to FIG. 1A.

FIG. 1C illustrates simulant calibration based on calibration zones, in accordance with one or more embodiments of the present disclosure.

It should be noted that the plot in FIG. 1C is the same as in FIGS. 1A and 1B. However, in FIG. 1C, each ROI centroid is labeled as C₁-C₅ to correspond with the calculations shown in FIG. 1C. Further, plot centroids are labeled as p_{ref,1}-p_{ref,3} for reference plots, while canary plot centroids are denoted by p_{can,1}-p_{can,3} also in order to correspond with the calculations shown in FIG. 1C.

Further, FIG. 1C provides two graphs for each ROI. Each graph provides a VOI based on both the canary plot and the reference plot. Additionally, for each ROI, one plot illustrates the error for the VOI calculations (e.g., as a distance between VOI and VOI). It should be noted that for ROIs 108a-108c the error is a computed error, while for ROI 108d and ROI 108e the error is an estimated error based on the lack of APs 112 in ROI 108d and ROI 108e.

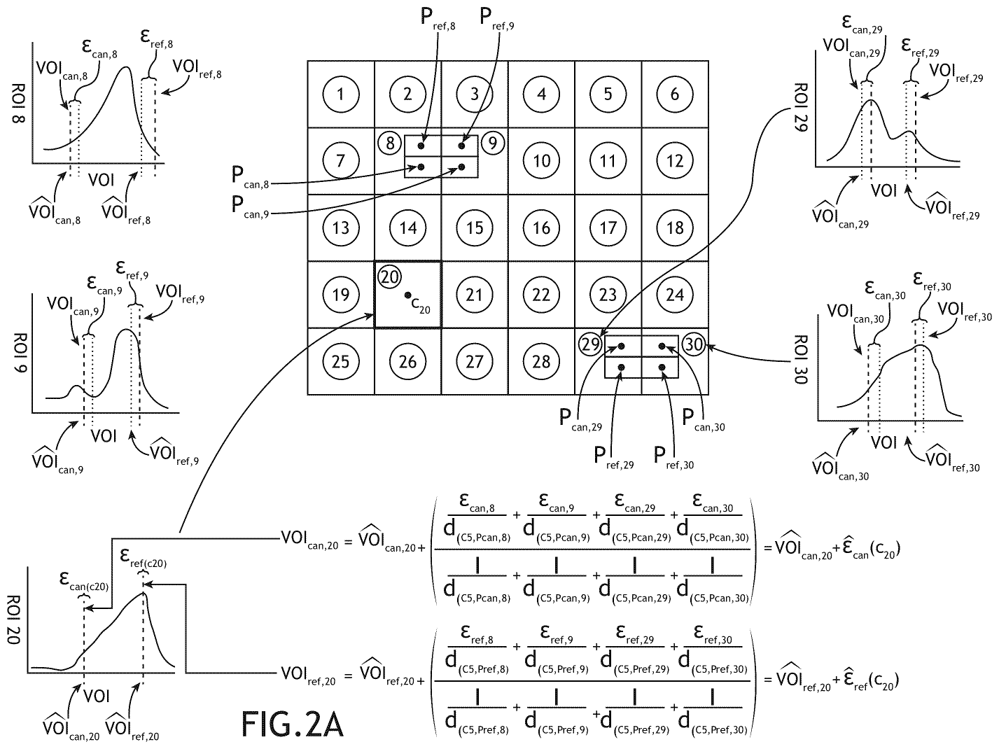

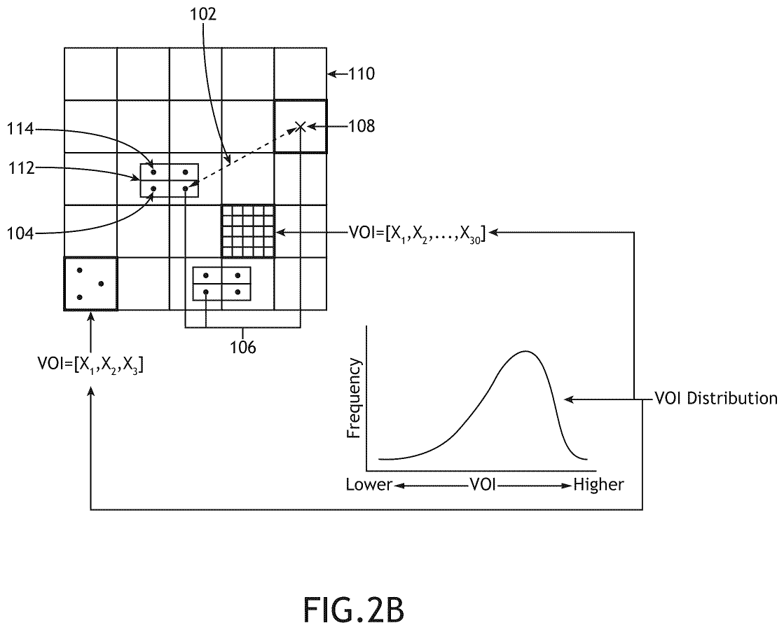

FIG. 2A illustrates simulant calibration based on calibration grid cells, in accordance with one or more embodiments of the present disclosure.

In FIG. 2A, the ROIs 108 are configured as calibration grid cells instead of calibration zones (e.g., the calibration zones of FIGS. 1A-1C). In this way, each calibration grid cell may be its own ROI 108. For example, in FIG. 2A there are 30 calibration grid cells (e.g., calibration grid cells 1-30). Further, each calibration grid cell may have its own ROI centroid 106 (e.g., c₂₀ in calibration grid cell 20).

The calibration grid may also have any number of APs. Here, for example, there are four APs 112, with one in each of calibration grid cells 8, 9, 29, and 30. Each AP 112 of the calibration grid cell may contain a reference plot 114 and a canary plot 104, with each of the reference plot 114 and canary plot 104 having their own plot centroid 116 (e.g., p_{ref,8} and p_{can,8}). In this way, VOI and error may be calculated for any calibration grid cell without an AP 112 in the same manner as described with reference to FIGS. 1A-1C and Equations 1-7.

FIG. 2B illustrates simulant calibration when ROIs 108 are configured as calibration grid cells, in accordance with one or more embodiments of the present disclosure.

For example, FIG. 2B illustrates how VOI may be calculated as a set of values (e.g., to form a frequency distribution plot) at various points in an ROI 108. Measuring VOI within calibration grid cells may either occur at selected points or in sub-cells of the calibration grid cells.

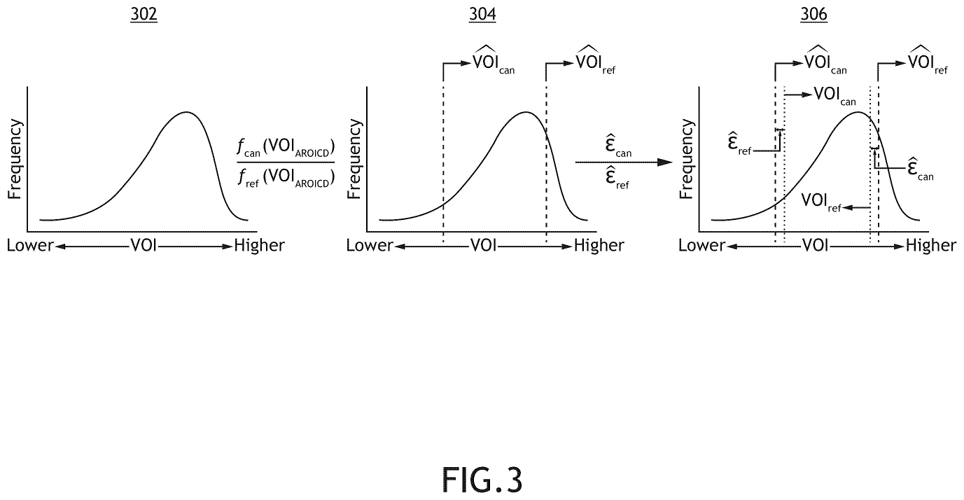

FIG. 3 illustrates frequency distribution graphs used in simulant calibration, in accordance with one or more embodiments of the present disclosure.

In embodiments, a first graph 302 is created. For example, the first graph 302 may be a distribution of VOI for an AROI (e.g., a ROI 108 without an AP 112). For instance, the VOI may be determined in a variety of locations of the AROI such that a distribution of the different values may be collected and represented on the first graph 302.

In embodiments, a second graph 304 is created. For example, the simulant calibration function may be applied for the reference plot 114 and canary plot 104 to determine the VOI value at the reference plot 114 and the canary plot 104. These VOI values may then be marked on the second graph 304.

In embodiments, a third graph 306 is created. For example, an estimated error may be calculated for the VOI value at the reference plot 114 and the canary plot 104. After the error estimate has been calculated the VOI value for the reference plot 114 and the canary plot 104 may be shifted based on the estimated error.

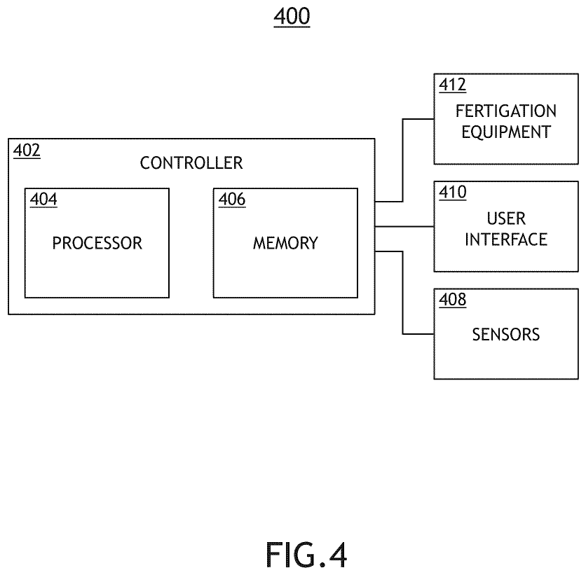

FIG. 4 illustrates a block diagram of a system 400 for carrying out simulant calibration, in accordance with one or more embodiments of the present disclosure.

In embodiments, the system 400 further includes a controller 402 communicatively coupled to any components therein. In some embodiments, the controller 402 includes one or more processors 404. For example, the one or more processors 404 may be configured to execute a set of program instructions maintained in a memory 406, or memory device. The one or more processors 404 of a controller 402 may include any processing element known in the art. In this sense, the one or more processors 404 may include any microprocessor-type device configured to execute algorithms and/or instructions.

The one or more processors 404 of a controller 402 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 404 may include any device configured to execute algorithms and/or instructions (e.g., program instructions stored in memory). In some embodiments, the one or more processors 404 may be embodied as a desktop computer, mainframe computer system, workstation, image computer, parallel processor, networked computer, or any other computer system configured to execute a program configured to operate or operate in conjunction with the system 400, as described throughout the present disclosure. Moreover, different subsystems of system 400 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 402 may include one or more controllers housed in a common housing or within multiple housings. In this way, any controller or combination of controllers may be separately packaged as a module suitable for integration into the system 400.

The memory 406 may include any storage medium known in the art suitable for storing program instructions executable by the associated one or more processors 404. For example, the memory 406 may include a non-transitory memory medium. By way of another example, the memory 406 may include, but is not limited to, a read-only memory (ROM), a random-access memory (RAM), a magnetic or optical memory device (e.g., disk), a magnetic tape, a solid-state drive, and the like. It is further noted that the memory 406 may be housed in a common controller housing with the one or more processors 404. In some embodiments, the memory 406 may be located remotely with respect to the physical location of the one or more processors 404 and the controller 402. For instance, the one or more processors 404 of the controller 402 may access a remote memory (e.g., server), accessible through a network (e.g., internet, intranet, and the like).

The controller 402 may direct (e.g., through control signals) and/or receive data from any components or sub-systems of the system 400 such as, but not limited to a set of sensors 408. For example, the sensors 408 may be configured to collect multispectral optical reflectance data. This multispectral optical reflectance data may be used with the system 400, and the program instructions defined herein to cause the system 400 to perform augmented simulant calibration. The controller 402 may further be configured to perform any of the various process steps described throughout the present disclosure.

The sensors 408 may also be configured to measure in-field soil salinity levels and/or nitrate concentration along with the optical reflectance measurements of the crop canopy.

In embodiments, the system 400 includes a user interface 410 communicatively coupled to the controller 402. In one embodiment, the user interface 410 may include, but is not limited to, one or more desktops, laptops, tablets, and the like. In another embodiment, the user interface 410 includes a display used to display data of the system 400 to a user. The display of the user interface 410 may include any display known in the art. For example, the display may include, but is not limited to, a liquid crystal display (LCD), an organic light-emitting diode (OLED) based display, or a cathode-ray tube (CRT) display. Those skilled in the art should recognize that any display device capable of integration with a user interface 410 is suitable for implementation in the present disclosure. In another embodiment, a user may input selections and/or instructions responsive to data displayed to the user via a user input device of the user interface 410.

For example, the user interface 410 may display a map of a field outlining calibration zones (e.g., as shown in FIGS. 1A-1C) or a calibration grid with corresponding calibration grid cells (e.g., as shown in FIGS. 2A-2B). Further, the user interface 410 may display various outputs of Equations 1-7 and/or display the graphs discussed in FIG. 3 (e.g., and the graphs accompanying FIGS. 1C-2B).

The system 400 may also include nutrient application equipment 412 (e.g., and/or chemigation equipment). The nutrient application equipment 412 may include any nutrient application equipment known in the art, including, but not limited to, side dress applicators, aerial spray applicators, highboy applicators, and/or fertigation equipment (e.g., irrigation systems, pumps, and/or reservoirs). The controller 402 and/or the processors 404 therein may be configured to control (e.g., alter) operation of the nutrient application equipment 412 based on the augmented simulant calibration process. For example, the processors 404 may save measurements from the ROIs calculated by the augmented simulant calibration process in a data file. The processors 404 may use the information on the data file to control the nutrient application equipment 412. For example, based on information from the ROIs 108, the processors 404 may be configured to control the nutrient application equipment 412 (e.g., control amounts of chemicals (e.g., fertilizers) or water dispersed through the nutrient application equipment).

In embodiments, the processors 404 are configured to execute program instructions. For example, the program instructions may be configured to cause the processors 404 to execute the steps of the method 500 disclosed herein.

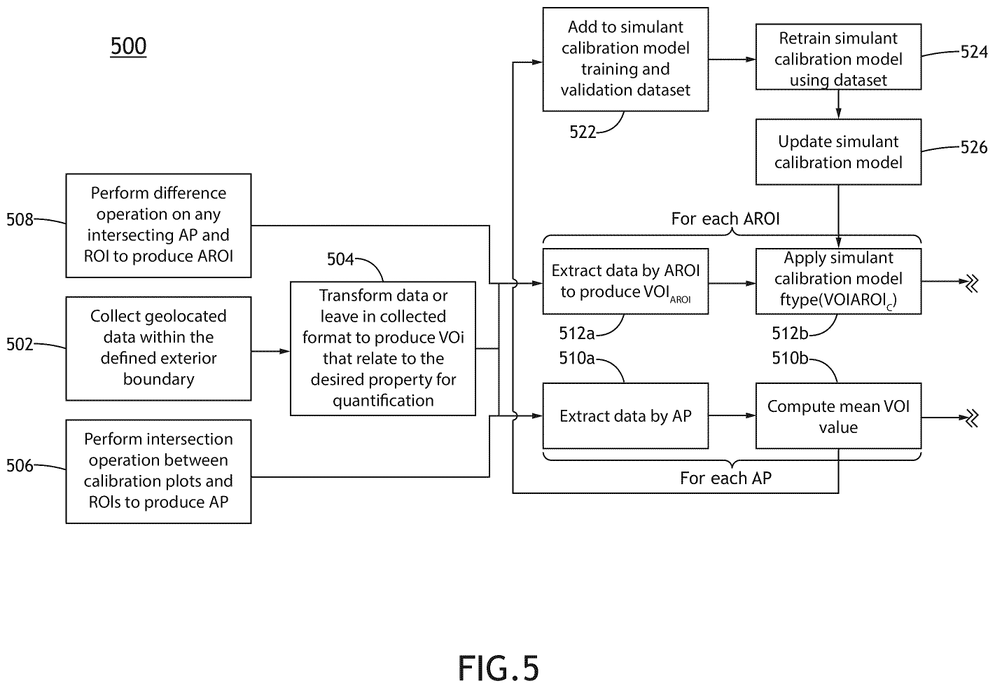

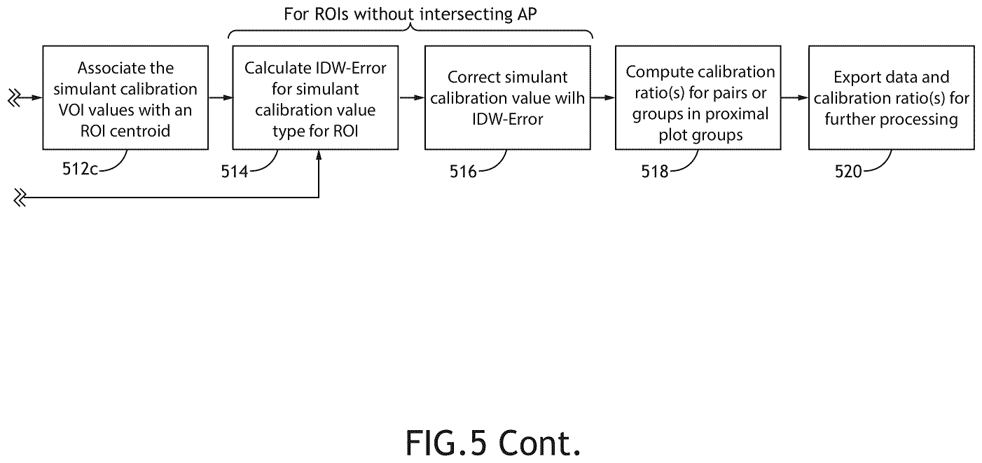

FIG. 5 illustrates a flow diagram of a method 500 for carrying out simulant calibration, in accordance with one or more embodiments of the present disclosure.

In embodiments, the method 500 includes a step 502 of collecting geolocated data for an entire area, wherein the entire area is defined by an exterior boundary. For example, the entire area may be a field, or a subset of a field. The exterior boundary defining the entire area may be the perimeter of a field, or some arbitrary outline based on other factors (e.g., geography, topology, elevation, or the like). The geolocated data may include values of interest for that particular area.

In embodiments, the method 500 includes a step 504 of transforming the collected geolocated data for the entire area to produce values of interest (VOI) or leaving the collected geolocated data in a collected format for the entire area to produce values of interest (VOI). For example, the model being used to analyze the geolocated data (e.g., VOIs) may require or significantly benefit from transforming the geolocated data, while other models may not benefit from transforming the geolocated data.

In embodiments, the method 500 includes a step 506 of performing an intersection operation on any location where calibration plots intersect a region of interest (ROI) to produce analytic plots (APs). The intersection operation may make a map of areas where calibration plots (e.g., reference and/or canary plots) intersect (e.g., overlap) with a particular region of interest. In this way, the overlapping areas may be considered to be APs.

In embodiments, the method 500 includes a step 508 of performing a difference operation on any location where the APs intersect the ROI to produce an analytic ROI (AROI).

In embodiments, the method 500 includes a step 510a of extracting one or more values of interest (VOI) for the entire area defined by the exterior boundary for each AP. Within each AP, VOIs may be measured (e.g., with a sensor). It may be advantageous for higher numbers of VOIs to be measured (e.g., to improve accuracy) within each AP.

In embodiments, the method 500 includes a step 510b of computing a mean VOI for each AP.

In embodiments, the method 500 includes a step 512a of extracting the VOIs within each AROI geospatial boundary to form an AROI VOI distribution. Within each AROI, VOIs may be measured (e.g., with a sensor). It may be advantageous for higher numbers of VOIs to be measured (e.g., to improve accuracy) within each AROI.

In embodiments, the method 500 includes a step 512b of applying one or more simulant calibration models to the AROI VOI distribution to determine simulant calibration VOI values. The simulant calibration models may be predetermined. Further, the simulant calibration models may be different for different areas, or may change based on other considerations.

In embodiments, the method 500 includes a step 512c of associating the simulant calibration VOI values with an AROI centroid. For example, the AROI centroid may be the center of mass of the AROI. Further, the simulant calibration VOI values may be associated with the AROI centroid to approximate a value for the entire AROI.

In embodiments, the method 500 includes a step 514 of computing error between the mean VOI value for each AP and the simulation calibration VOI values for the AROI associated with each AP. For example, error may be calculated using Equations 1-7.

In embodiments, the method 500 includes a step 516 of correcting the simulant calibration VOI values for ROI that do not intersect the APs. The step 516 of correcting the simulant calibration VOI values for ROI that do not intersect the APs may include sub steps of: computing inverse distances between an ROI centroid and an AP centroid; computing an inverse distance weight (IDW) estimated error for each simulant calibration VOI value type for the ROI; and correcting each simulant calibration VOI value with the IDW estimated error.

In embodiments, the method 500 includes a step 518 of computing one or more calibration ratios for pairs in proximal plot groups. The calibrations ratios may include ratios such as a sufficiency index (SI).

In embodiments, the method 500 includes a step 520 of delivering the one or more calibration ratios to a recommendation algorithm for further transformation and processing.

In embodiments, the method 500 includes a step 522 of adding the AP mean VOI values and the AROI VOI distribution for the intersecting ROI to a simulant calibration model training and validation database. For example, the training and validation data base may be used to improve models in the future or validate results of a model. By way of another example, the model training may include a cost-function. The cost-function may be designed to prioritize higher levels of calibration accuracy for data values farther from the mean within training data because these values are important to making calibrated geospatial data usable in decision algorithms.

In embodiments, the method 500 includes a step 524 of training and validating the simulant calibration model with an updated simulant calibration model training and validation database in order to update the executed model.

In embodiments, the method 500 includes a step 526 of updating the simulant calibration model.

It is also contemplated that embodiments of the present disclosure may incorporate historical leaf tissue nutrient concentration correlations with vegetation index (VI) values to correlate maximum and minimum nitrate concentration. Further, nutrient-specific vegetation indices incorporating 3 or more spectral bands may be integrated.

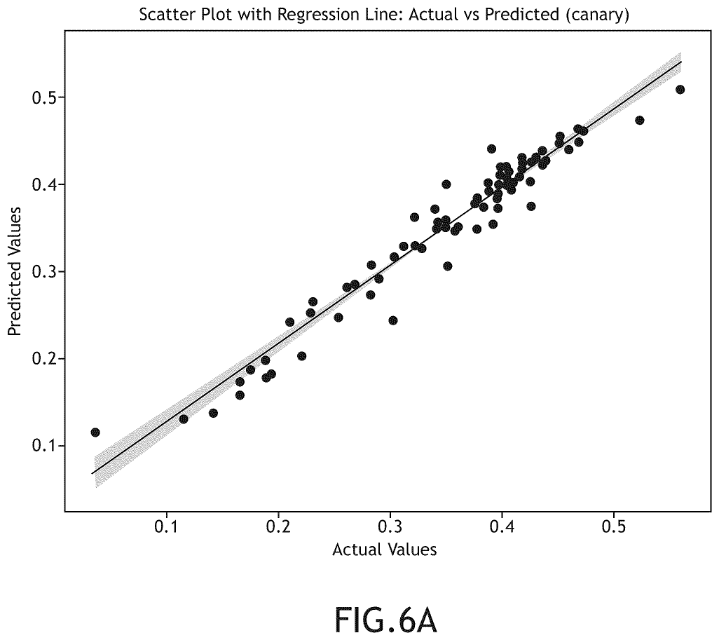

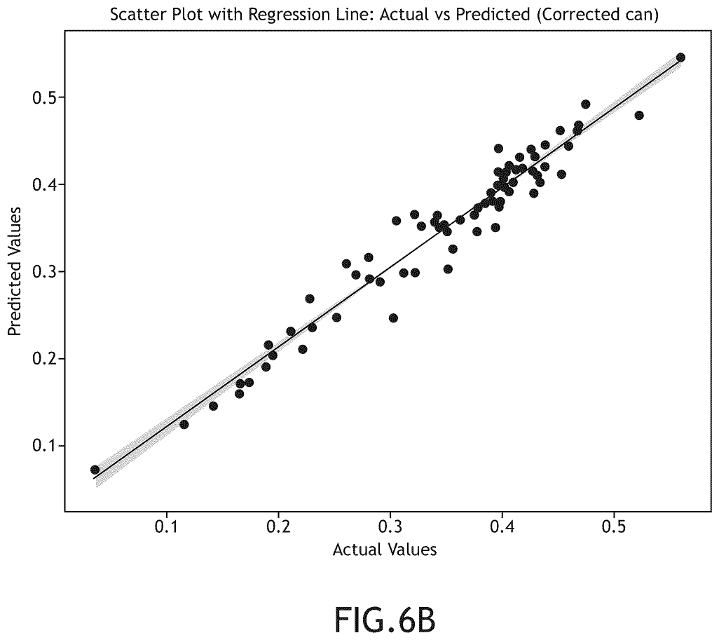

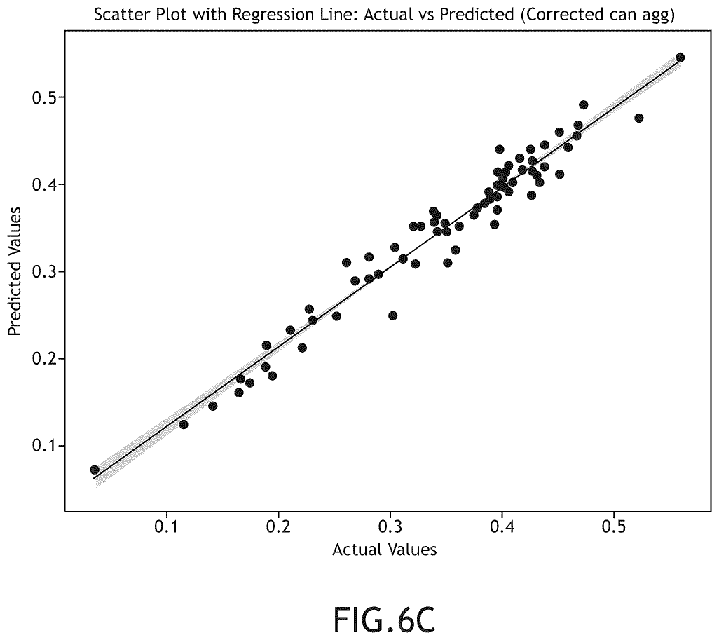

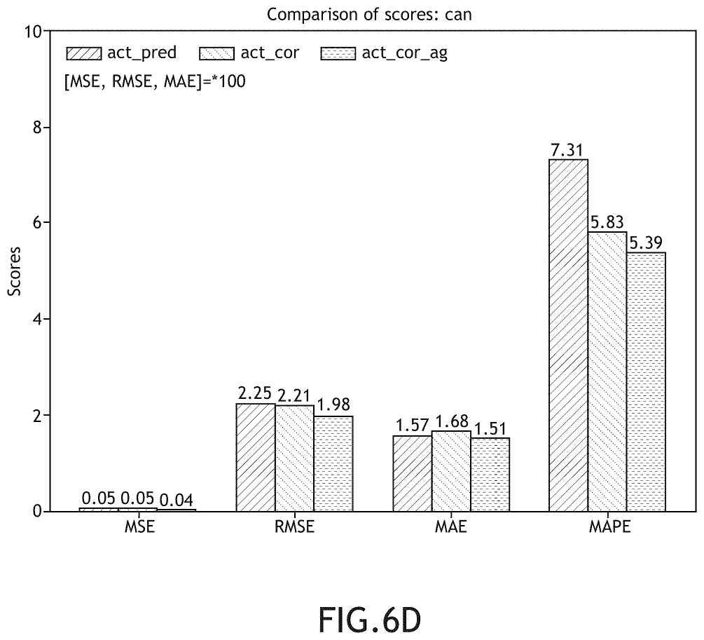

Referring now to FIGS. 6A-8D, graphs demonstrating the efficacy of the system 400 and method 500, as disclosed herein, are shown, in accordance with one or more embodiments of the present disclosure.

FIG. 6A illustrates a graph showing actual versus predicted values for a canary plot, in accordance with one or more embodiments of the present disclosure. Specifically, FIG. 6A illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a canary plot.

FIG. 6B illustrates a graph showing actual versus predicted values for a corrected canary plot, in accordance with one or more embodiments of the present disclosure. Specifically, FIG. 6B illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected canary plot.

FIG. 6C illustrates a graph showing actual versus predicted values for a corrected canary aggregate plot, in accordance with one or more embodiments of the present disclosure. Specifically, FIG. 6C illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected canary aggregate plot.

FIG. 6D illustrates a graph showing a comparison of correlative measures for the graphs in FIGS. 6A-6C, in accordance with one or more embodiments of the present disclosure. For each of the plots shown in FIGS. 6A-6C, FIG. 6D illustrates a measure of mean squared error (MSE), root mean squared error (RMSE), mean absolute error (MAE), and mean absolute percentage error (MAPE). Further, the values shown in FIG. 6D for MSE, RMSE, and MAE are multiplied by 100 to obtain the value shown on the graph.

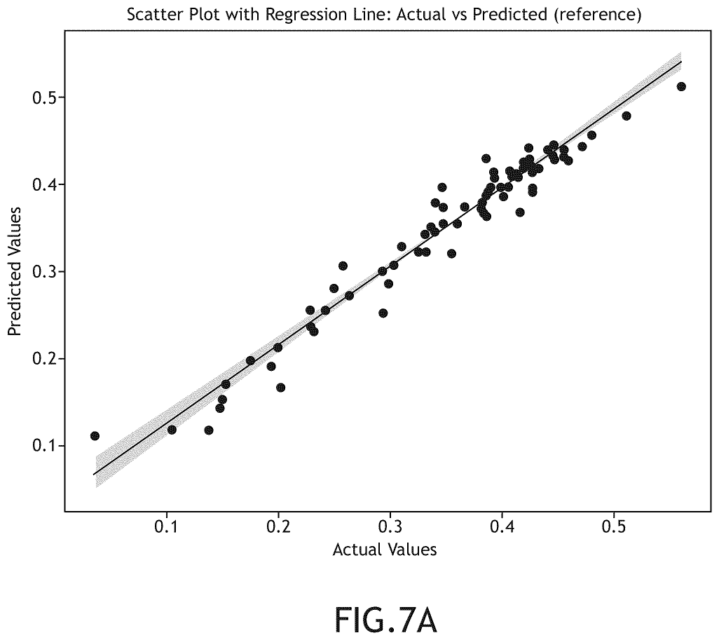

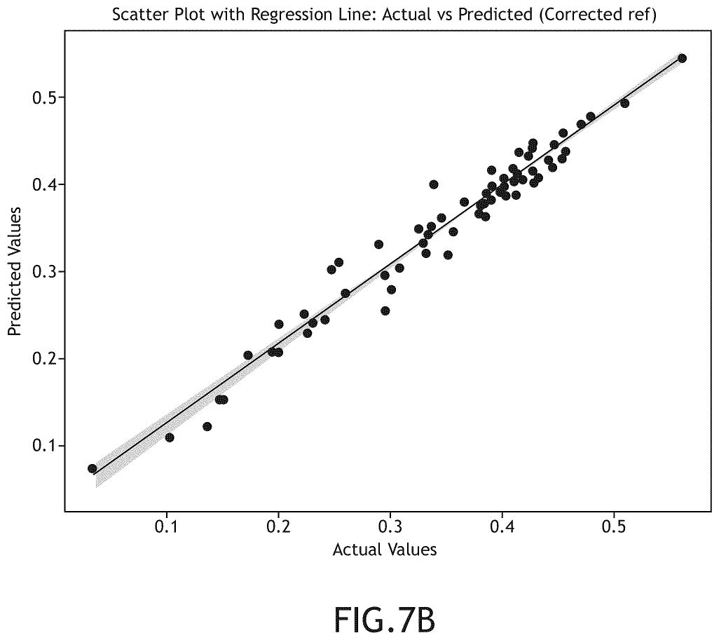

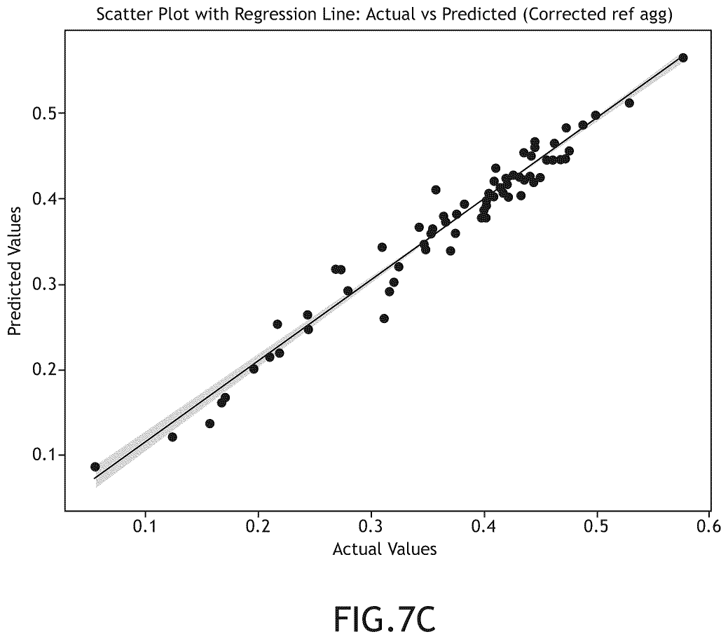

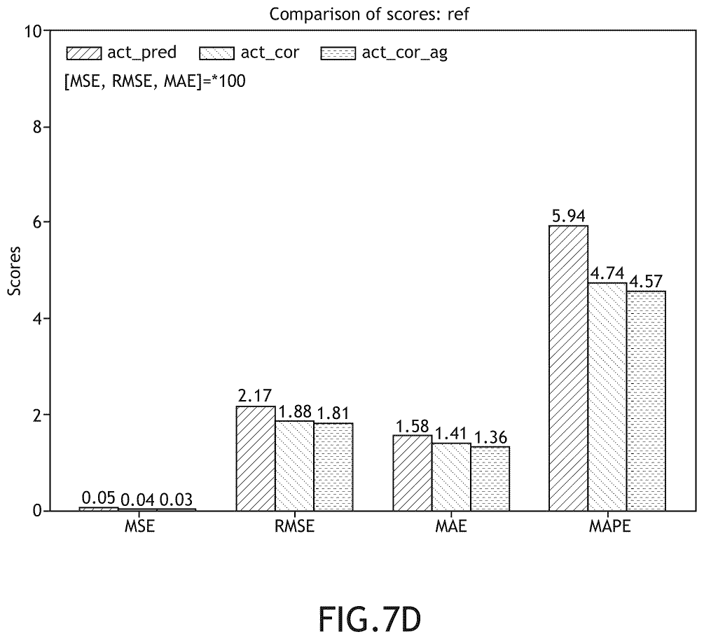

FIG. 7A illustrates a graph showing actual versus predicted values for a reference plot, in accordance with one or more embodiments of the present disclosure. Specifically, FIG. 7A illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a reference plot.

FIG. 7B illustrates a graph showing actual versus predicted values for a corrected reference plot, in accordance with one or more embodiments of the present disclosure. Specifically, FIG. 7B illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected reference plot.

FIG. 7C illustrates a graph showing actual versus predicted values for a corrected reference aggregate plot, in accordance with one or more embodiments of the present disclosure. Specifically, FIG. 7C illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected reference aggregate plot.

FIG. 7D illustrates a graph showing a comparison of correlative measures for the graphs in FIGS. 7A-7C, in accordance with one or more embodiments of the present disclosure. For each of the plots shown in FIGS. 7A-7C, FIG. 7D illustrates a measure of MSE, RMSE, MAE, and MAPE. Further, the values shown in FIG. 7D for MSE, RMSE, and MAE are multiplied by 100 to obtain the value shown on the graph.

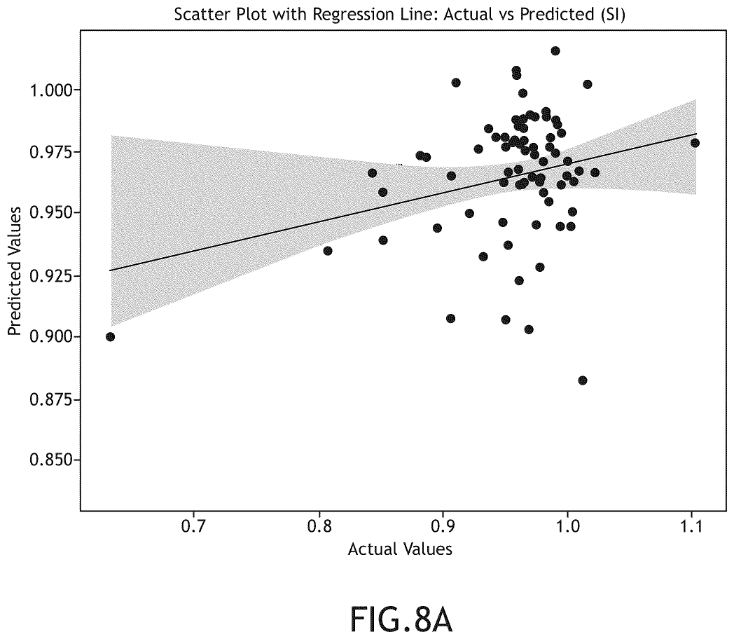

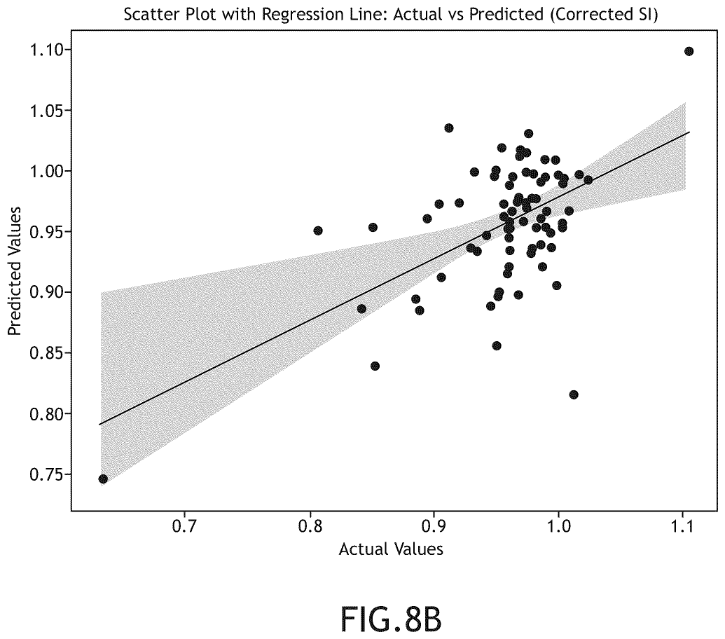

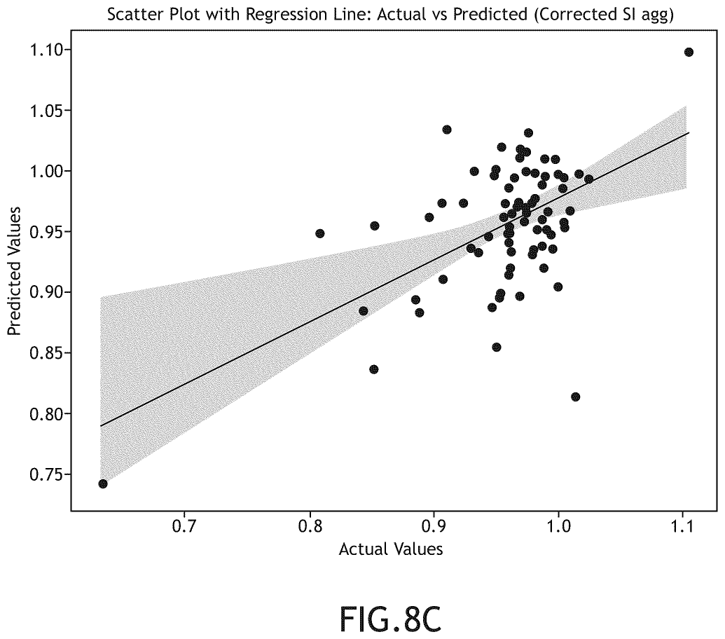

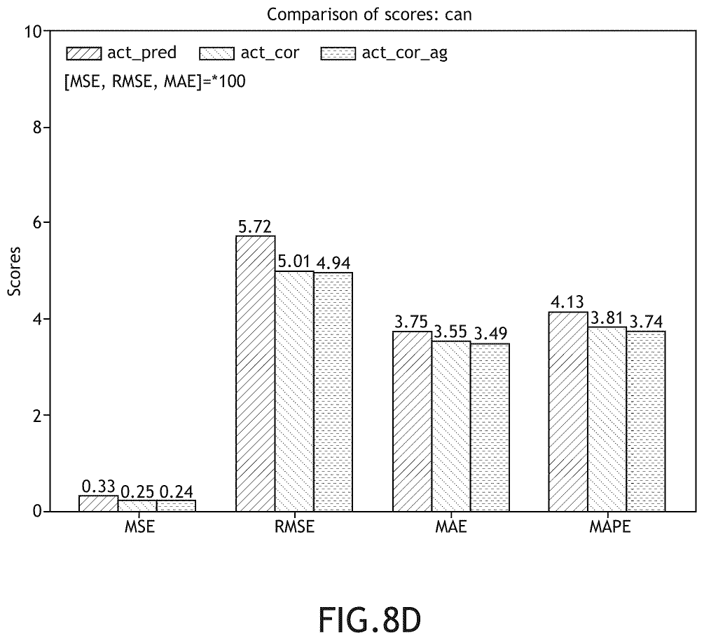

FIG. 8A illustrates a graph showing actual versus predicted values for a sufficiency index (SI) plot, in accordance with one or more embodiments of the present disclosure. Specifically, FIG. 8A illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for an SI plot. For example, the data shown in FIGS. 8A-8D with reference to an SI plot may represent data collected and simulated for a ROI that does not have a reference plot or a canary plot.

FIG. 8B illustrates a graph showing actual versus predicted values for a corrected SI plot, in accordance with one or more embodiments of the present disclosure. Specifically, FIG. 8B illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected SI plot.

FIG. 8C illustrates a graph showing actual versus predicted values for a corrected SI aggregate plot, in accordance with one or more embodiments of the present disclosure. Specifically, FIG. 8C illustrates a collection of data points with each having a correlating actual value (e.g., the x-coordinate on an (x, y) plot) and a predicted value (e.g., the y-coordinate on an (x, y) plot). Further, a trendline is presented, showing a correlation between the predicted values and the actual values for a corrected SI aggregate plot.

FIG. 8D illustrates a graph showing a comparison of correlative measures for the graphs in FIGS. 8A-8C, in accordance with one or more embodiments of the present disclosure. For each of the plots shown in FIGS. 8A-8C, FIG. 8D illustrates a measure of MSE, RMSE, MAE, and MAPE. Further, the values shown in FIG. 8D for MSE, RMSE, and MAE are multiplied by 100 to obtain the value shown on the graph.

It is noted that the scope of the present disclosure is not limited to the utilization of analytic plots (APs). Rather, it is contemplated that embodiments of the present disclosure may be adapted to provide control, instructions, and/or guidance to nutrient application equipment (e.g., fertigation equipment) without the use of analytic plots. In this regard, the various embodiments of the present disclosure may be configured to provide one or more outputs using an adapted calculation and calibration method to provide control, instructions, and/or guidance to nutrient application equipment.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed is:

1. A system for simulant calibration comprising:
a controller, wherein the controller includes one or more processors configured to execute program instructions stored on memory, the program instructions configured to cause the one or more processors to:
collect geolocated data for an entire area, wherein the entire area is defined by an exterior boundary;
generate analytic plots and analytic regions of interest;
extract one or more values of interest for the entire area defined by the exterior boundary for each analytic plot;
generate an analytic region of interest value of interest distribution;
determine simulant calibration value of interest values associated with an analytic region of interest centroid;
correct the simulant calibration value of interest values for regions of interest that do not intersect the analytic plots based on an estimated error;
compute one or more calibration ratios for pairs in proximal plot groups to use for simulant application recommendations; and
update an executed model and a simulant calibration model training and validation database.

2. The system of claim 1, wherein the program instructions are further configured to cause the one or more processors to:
transform the collected geolocated data for the entire area to produce values of interest.

3. The system of claim 1, wherein the program instructions are further configured to cause the one or more processors to:
leave the collected geolocated data in a collected format for the entire area to produce values of interest.

4. The system of claim 1, wherein the program instructions are further configured to cause the one or more processors to:
update a simulant calibration model.

5. The system of claim 1, wherein the one or more calibration ratios comprise a sufficiency index.

6. The system of claim 1, wherein the one or more processors configured to correct the simulant calibration value of interest values for the regions of interest that do not intersect the analytic plots are further configured to:
compute inverse distances between a region of interest centroid and an analytic plot centroid;
compute an inverse distance weight estimated error for each simulant calibration value of interest value type for the region of interest; and
correct each simulant calibration value of interest value with the inverse distance weight estimated error.

7. The system of claim 1, further comprising:
one or more sensors, configured to collect multispectral optical reference data.

8. The system of claim 1, further comprising:
a user interface.

9. The system of claim 1, further comprising:
nutrient application equipment.

10. The system of claim 9, wherein the program instructions are further configured to cause the one or more processors to:
save measurements from the regions of interest into a data file.

11. The system of claim 10, wherein the program instructions are further configured to cause the one or more processors to:
control the nutrient application equipment based on the measurements from the regions of interest saved in the data file.

12. A system for simulant calibration comprising:
a controller, wherein the controller includes one or more processors configured to execute program instructions stored on memory, the program instructions configured to cause the one or more processors to:
collect geolocated data for an entire area, wherein the entire area is defined by an exterior boundary;
perform an intersection operation on any location where calibration plots intersect a region of interest to produce analytic plots;
perform a difference operation on any location where the analytic plots intersect the region of interest to produce an analytic region of interest;
extract one or more values of interest for the entire area defined by the exterior boundary for each analytic plot;
compute a mean value of interest value for each analytic plot;
extract the one or more values of interest within each analytic region of interest geospatial boundary to form an analytic region of interest value of interest distribution;
apply one or more simulant calibration models to the analytic region of interest value of interest distribution to determine simulant calibration value of interest values;
associate the simulant calibration value of interest values with an analytic region of interest centroid;
compute error between the mean value of interest value for each analytic plot and the simulant calibration value of interest values for the analytic region of interest associated with each analytic plot;
correct the simulant calibration value of interest values for regions of interest that do not intersect the analytic plots;
compute one or more calibration ratios for pairs in proximal plot groups; and
deliver the one or more calibration ratios to a recommendation algorithm for further transformation and processing.

13. The system of claim 12, wherein the program instructions are further configured to cause the one or more processors to:
add the mean value of interest values for each analytic plot and the analytic region of interest value of interest distribution for the intersecting region of interest to a simulant calibration model training and validation database; and
train and validate the one or more simulant calibration models with an updated simulant calibration model training and validation database in order to update an executed model.

14. The system of claim 12, wherein the program instructions are further configured to cause the one or more processors to:
transform the collected geolocated data for the entire area to produce values of interest.

15. The system of claim 12, wherein the program instructions are further configured to cause the one or more processors to:
leave the collected geolocated data in a collected format for the entire area to produce values of interest.

16. The system of claim 12, wherein the program instructions are further configured to cause the one or more processors to:
update the one or more simulant calibration models.

17. The system of claim 12, wherein the one or more calibration ratios comprise a sufficiency index.

18. The system of claim 12, wherein the one or more processors configured to correct the simulant calibration value of interest values for the regions of interest that do not intersect the analytic plots are further configured to:
compute inverse distances between a region of interest centroid and an analytic plot centroid;
compute an inverse distance weight estimated error for each simulant calibration value of interest value type for the region of interest; and
correct each simulant calibration value of interest value with the inverse distance weight estimated error.

19. The system of claim 12, further comprising:
one or more sensors, configured to collect multispectral optical reference data.

20. The system of claim 12, further comprising:
a user interface.

21. The system of claim 12, further comprising:
nutrient application equipment.

22. The system of claim 21, wherein the program instructions are further configured to cause the one or more processors to:
save measurements from the regions of interest into a data file.

23. The system of claim 22, wherein the program instructions are further configured to cause the one or more processors to:
control the nutrient application equipment based on the measurements from the regions of interest saved in the data file.

24. A method of simulant calibration comprising:
collecting geolocated data for an entire area, wherein the entire area is defined by an exterior boundary;
performing an intersection operation on any location where calibration plots intersect a region of interest to produce analytic plots;
performing a difference operation on any location where the analytic plots intersect the region of interest to produce an analytic region of interest;
extracting one or more values of interest for the entire area defined by the exterior boundary for each analytic plot;
computing a mean value of interest value for each analytic plot;
extracting the one or more values of interest within each analytic region of interest geospatial boundary to form an analytic region of interest value of interest distribution;
applying one or more simulant calibration models to the analytic region of interest value of interest distribution to determine simulant calibration value of interest values;
associating the simulant calibration value of interest values with an analytic region of interest centroid;
computing error between the mean value of interest value for each analytic plot and the simulant calibration value of interest values for the analytic region of interest associated with each analytic plot;
correcting the simulant calibration value of interest values for regions of interest that do not intersect the analytic plots;
computing one or more calibration ratios for pairs in proximal plot groups; and
delivering the one or more calibration ratios to a recommendation algorithm for further transformation and processing.

25. The method of claim 24, further comprising:
adding the mean value of interest values for each analytic plot and the analytic region of interest value of interest distribution for the intersecting region of interest to a simulant calibration model training and validation database; and
training and validating the one or more simulant calibration models with an updated simulant calibration model training and validation database in order to update an executed model.

26. The method of claim 24, wherein correcting the simulant calibration value of interest values for the regions of interest that do not intersect the analytic plots comprises:
computing inverse distances between a region of interest centroid and an analytic plot centroid;
computing an inverse distance weight estimated error for each simulant calibration value of interest value type for the region of interest; and
correcting each simulant calibration value of interest value with the inverse distance weight estimated error.

27. The method of claim 24, wherein the method further comprises:
transforming the collected geolocated data for the entire area to produce values of interest.

28. The method of claim 24, wherein the method further comprises:
leaving the collected geolocated data in a collected format for the entire area to produce values of interest.

29. The method of claim 24, wherein the method further comprises:
updating the one or more simulant calibration models.
